(19) United States
(12) Patent Application Publication
(10) Pub. No.: US 2012/0187856 A1
(43) Pub. Date: Jul. 26, 2012

(54) PACKAGE STRUCTURE OF FULL-COLOR LED INTEGRATED WITH DRIVING MECHANISM AND CURRENT LIMITING ELEMENTS

(76) Inventor: Hsien-Jung HUANG, Chung Ho (TW)

(21) Appl. No.: 13/432,865

(22) Filed: Mar. 28, 2012

Related U.S. Application Data
(63) Continuation-in-part of application No. 12/842,551, filed on Jul. 23, 2010.

(51) Int. Cl. H05B 37/02

(52) U.S. Cl. 315/210

(57) ABSTRACT

A package structure of full-color LED (Light Emitting Diode) integrated with driving mechanism and current limiting elements includes an driving IC (Integrated Circuit) chip, a red LED dice, a green LED dice, a blue LED dice. The IC chip has a driving mechanism to control the red LED dice, the green LED dice, and the blue LED dice. And the current limiting elements are integrated into the driving IC chip. By the specific arrangement of these internal elements, the package structure generates full-color light with high resolution, compact structure and high mixing uniformity, and also achieves low cost and decreases usage of space.

### BACKGROUND OF THE INVENTION

1. Field of the Invention

The present invention relates to a package structure of full-color LED (Light Emitting Diode) adapted to various LED displays with special light-shadow effects, and more particularly, to a package structure of full-color LED equipped with internal driving mechanism.

2. Related Art

Light plays a significant role for a very long time in human life. Accompanying with the constant progresses of science and technology, LED (Light Emitting Diode) has been invented in 1970s. With the advantages of compact size, long lifetime, low breakage, low power consumption, no heat radiation and no toxic pollution (such as mercury and etc.), comparing with conventional light sources, LED is now broadly utilized in our daily life.

Through the environment/economization policies driven by the governments around the world, LED is well-developed and applied to two major applications including display and illumination functions. Due to plenty of nonstop technology advancements, the conventional single-color LED is gradually unable to satisfy human's visual needs. Conventional large LED displays are constructed by LED matrixes with LED units arranged in lengthwise and transverse. The LED displays, which controlled by software, illuminate different lights to show desired texts or images.

If the size of the base plate of the single-one large LED display is huge, the manufacturing cost is increased. Also, it is hard to maintain or repair if some of the LED units are cracked. Therefore, the large LED display is formed by LED module plates now. However, the connection mechanism is complex which is not easy to assemble and carry.

Furthermore, for the LED units, the applicant provides a package structure of a full-color LED that is equipped with driving mechanism to achieve low cost and decreases usage of space, as U.S. Pat. No. .8,094,102. However, due to there have three current limiting resistors disposed therein. The used space is still large and the production costs is still high.

### SUMMARY OF THE INVENTION

The present invention provides a package structure integrated with driving mechanism and current limiting elements to reduce production costs and improve production yield rate.

Accordingly, the present invention discloses a package structure of full-color LED (Light Emitting Diode) including a power input, a power output, a clock input, a clock output, a serial data input, a serial data output, a carrier and a driving IC (Integrated Circuit) chip. The carrier has an inner space to dispose a red LED dice, a green LED dice and a blue LED dice. Each of the red, green and blue LED dices is respectively configured with a first electrode and a second electrode thereon. The first electrodes of the red LED dice, the green LED dice and the blue LED dice are connected to the power input through metal wiring. The driving IC chip is pasted on the carrier and respectively connect with the second electrode of each of the red, green and blue LED dices through metal wiring. The driving IC chip controls the red, green and blue LED dices after receiving an operation power from the power input and receiving a control signal from the clock input and the serial data input. The driving IC chip further sends out the operation power through the power output and also sending out the control signal through the clock output and the serial data output. Moreover the driving IC chip is further integrated with three current limiting elements to distribute the operation power into the red LED dice, the green LED dice and the blue LED dice respectively to ensure light colors generated by mixing lights of the LED dices and to form protections for the LED dices.

On the other hand, the present invention discloses a package structure of full-color LED (Light Emitting Diode) including a power input, a power output, a clock input, a clock output, a serial data input, a serial data output, a carrier and a driving IC (Integrated Circuit) chip. The power input has an inputting extension section. The carrier has an inner space to dispose a red LED dice, a green LED dice and a blue LED dice. Each of the red, green and blue LED dices is pasted on the inputting extension section of the power input to form electrical connection. The driving IC chip is pasted on the carrier and respectively connect with the red, green and blue LED dices through metal wiring. The driving IC chip controls the red, green and blue LED dices after receiving an operation power from the power input and receiving a control signal from the clock input and the serial data input. The driving IC chip further sends out the operation power through the power output and also sending out the control signal through the clock output and the serial data output. Moreover the driving IC chip is further integrated with three current limiting elements to distribute the operation power into the red LED dice, the green LED dice and the blue LED dice respectively to ensure light colors generated by mixing lights of the LED dices and to form protections for the LED dices.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 is a respective view for the LED module plate of the present invention;

FIG. 2 is a schematic view for the LED module plate of the present invention;

FIG. 3 is a explosive view for the LED module plate of the present invention;

FIG. 4 shows the LED module plates connected to each other according to the present invention;

FIG. 5 shows the details of the full-color LED units according to the present invention;

FIGS. 6A and 6B are schematic views of the LED module plates according to the present invention, illustrating using the positive area and the negative area for the power supply through holes;

FIGS. 7A and 7B are schematic views of the LED display structure according to the present invention, illustrating using a conductive connecting element to connect the power supply through holes of the LED module plates;

FIG. 8 is a schematic view of the package structure according to the present invention; and

FIG. 9 is a schematic view of another embodiment of the package structure according to the present invention.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

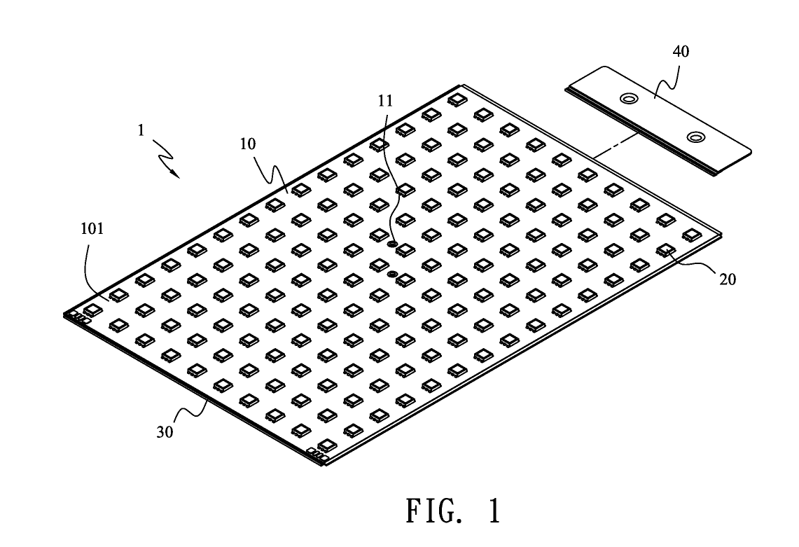

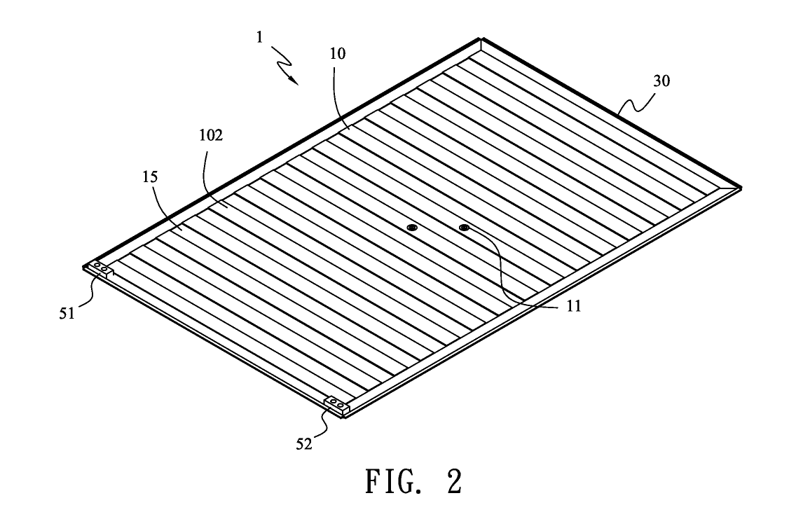

Please refer to FIG. 1, which is a respective view for the LED module plate of the present invention to show the front side of the LED module plate. Please refer to FIG. 2, which is a schematic view for the LED module plate of the present invention to show the back side of the LED module plate.

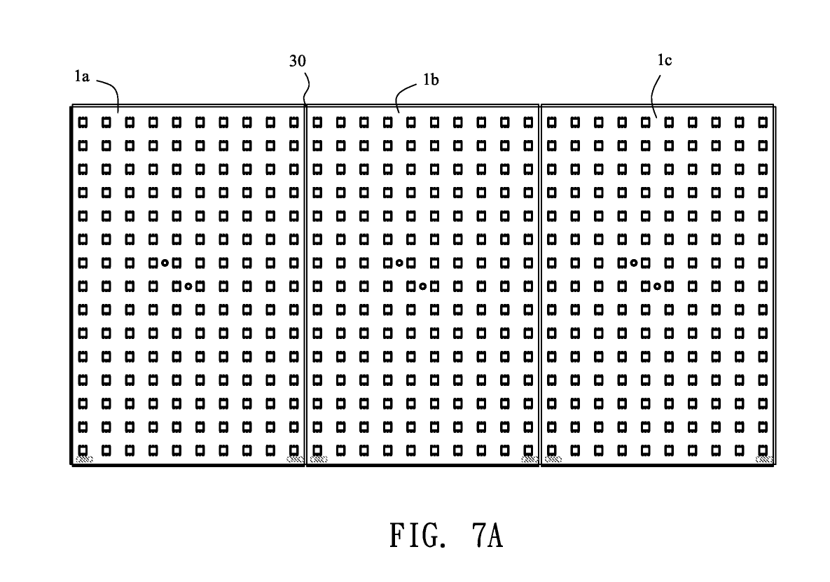

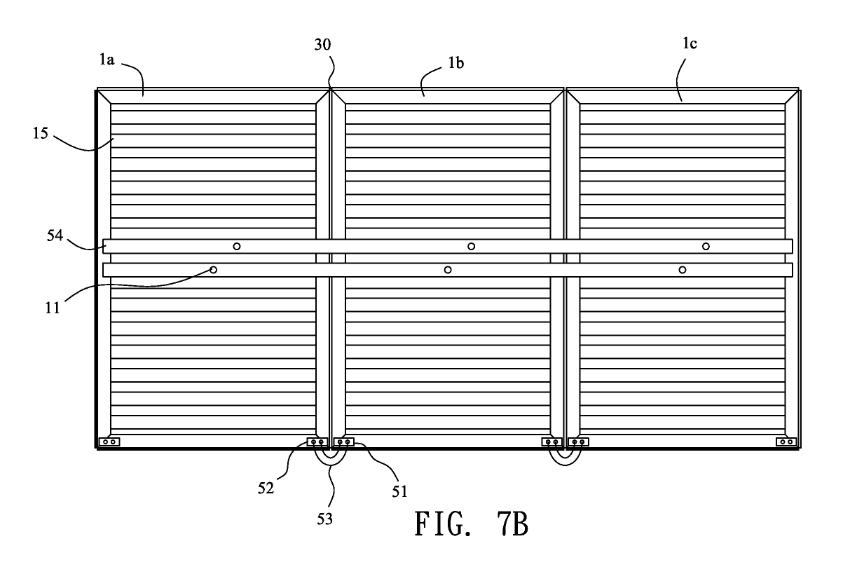

The LED (Light Emitting Diode) display structure having a plurality of LED module plates 1 which can be connected each other, also refer to FIG. 7A. The LED module plates 1 includes a flexible PCB (printed circuit board) 10, a plurality of protective plates 15, a plurality of full-color LED units 20 and connecting edge bandings 30. The flexible PCB 10 includes a first side 101 and a second side 102. The full-color LED units 20 are mounted on the first side 102 of the flexible PCB 10. The connecting edge bandings 30 disposed on the four edges of the LED module plates 1 to connect the adjacent LED module plates 1 to form a larger LED display. One of the connecting edge bandings 30 has a hanger 40 or clips the hanger 40. Therefore, it is easy to suspend the LED module plate 1.

The flexible PCB 10 is disposed a pair of power supply through holes 11, which pass through thereon, to receive a supply voltage. The second side 102 of the flexible PCB 10 has the protective plates 15, an input port 51 and an output port 52, please refer to FIG. 2. The input port 51 is connected to the full-color LED units 20 to receive a controlling signal and transmit to the full-color LED units 20. The output port 52 is also connected to the full-color LED units 20 to receive the controlling signal and transmit to the adjacent LED module plate 1. Therefore, the input port 51 and the output port 52 of the LED module plates 1 have the same specification to establish communication between of the LED module plates 1, also refer to FIG. 7.

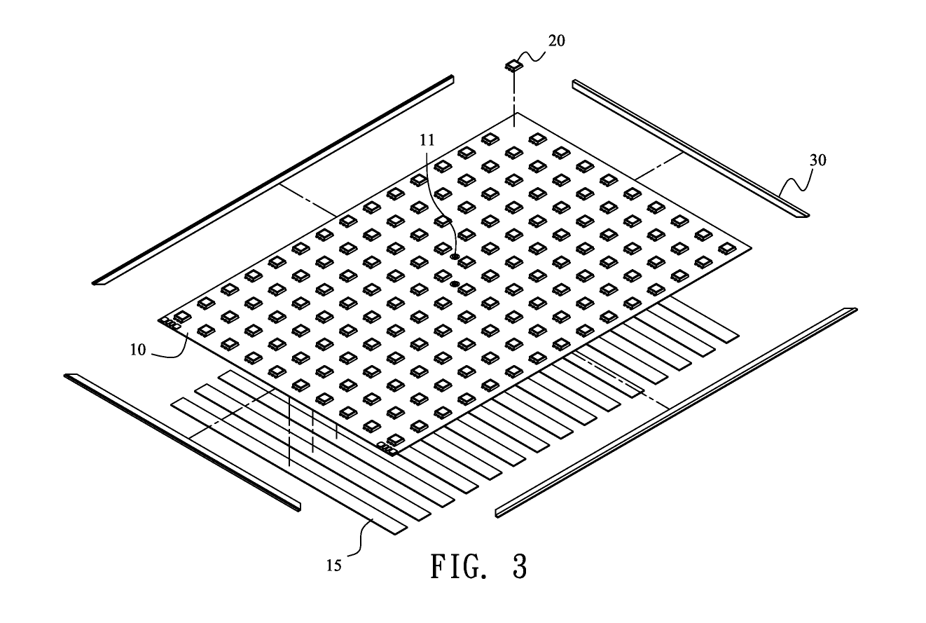

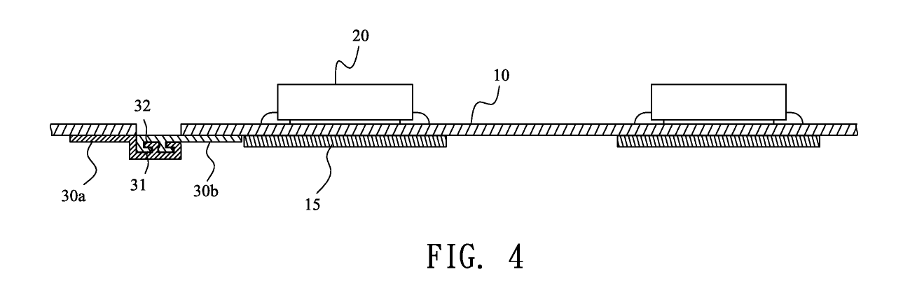

Please refer to FIG. 3, the full-color LED units 20 are disposed on the first side 101 of the flexible PCB 10, preferably the flexible PCB 10 has at least one transmission line 12 to connect to the input port 51, also to the output port 52, shown in FIGS. 7A and 7B. The full-color LED units 20 are RGB LED units with driving circuits respective to each colors. The full-color LED units 20 are disposed on the first side 101 of the flexible PCB 10, and the transmission line 12 connects the full-color LED units 20 to the input port 51 and the output port 52. Therefore, the full-color LED units 20 are connected to the transmission lines 22 to form a loop to receive the controlling signal by the input port 51. The protective plates 15, which is made of plastic, are pasted on the second side 102 of the flexible PCB 10 corresponding to the full-color LED units 10. The protective plate 15 is slightly border than the full-color LED unit 10, see FIG. 4, to protect connection between the full-color LED units 10 and the transmission line 12. As a result, even the LED module plates 1 is rolled for carrying or the external force, the connection between the full-color LED units 20 and the flexible PCB 10 or the transmission line 12 could be protected without damage or crack.

Please refer to FIG. 4, which shows the LED module plates 1 connected to each other according to the present invention. The connecting edge bandings 30 are disposed on the edges of the flexible PCB 10 by pasting, pressing, or melting. Each connecting edge banding 30 includes a hook 31 to form a track 32 thereunder, which is parallel to the edge. Therefore, the hook 31 of the right connecting edge banding 30b clips the track 32 of the left connecting edge banding 30a to connect the two adjacent LED module plates 1. Due to the hook-like and track structure, the hook 31 only can slide in the track 32 along the lengthwise direction of the connecting edge banding 30. Therefore, the connection relationship between the LED module plates 1 by the connecting edge bandings 30 is firm. As shown in FIG. 4, each of the connecting edge bandings 30a, 30b has two hooks 31 and two tracks 32 to make the connection be firmer.

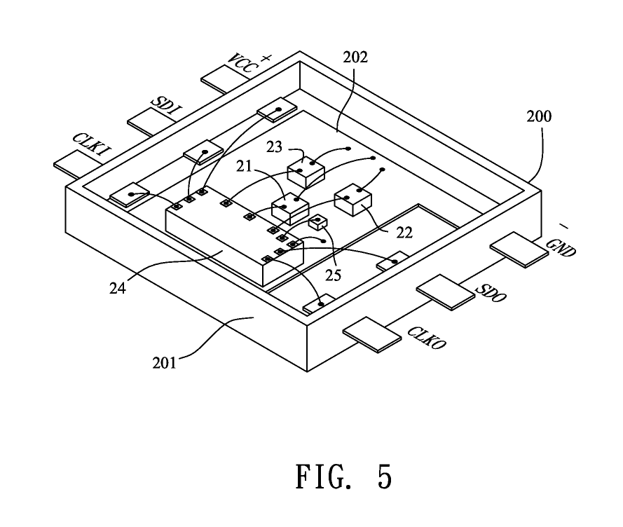

Moreover, the connecting edge bandings 30 are disposed on the second side 102 of the flexible PCB 10. When the LED module plates 1 connected to each other by the connecting edge bandings 30, the connecting edge bandings 30 would not protrude from surrounding to affect appearance. Please refer to FIG. 5, which shows the details of the full-color LED units according to the present invention.

The full-color LED units 20 includes a red LED dice 21, a green LED dice 22, a blue LED dice 23, and a driving IC chip 24, which are carried by a carrier 201. The full-color LED units 20 also includes a power input VCC, a power output GND, a clock input CLKI, a clock output CLKO, a serial data input SDI, and a serial data output SDO, which are extended outside the carrier 201. The power output GND also extends inside the carrier 201 to form a square extension portion 202. And the red LED dice 21, the green LED dice 22, the blue LED dice 23, and the driving IC chip 24 are disposed on the extension portion 202.

The red LED dice 21, the green LED dice 22, the blue LED dice 23 have a first pole and a second pole respectively. The first poles of the red LED dice 21, the green LED dice 22, the blue LED dice 23 connect to the extension portion 202, and the second poles of the red LED dice 21, the green LED dice 22, the blue LED dice 23 connect to the driving IC chip 24 by wire-bonding. And the driving IC chip 24 also connects to the power input VCC, the power output GND, the clock input CLKI, the clock output CLKO, the serial data input SDI, and the serial data output SDO by wire-bonding. Therefore, due to each full-color LED unit 20 has driving mechanism, the density of the arrangement for the full-color LED units 20 pasted on the LED module plate 1 is increased.

To control the supply voltage more precisely in a suitable range, the full-color LED unit 20 further includes a current limiting resistor 25. The current limiting resistor 25 is electrically connected to the driving IC chip 24 by wire-bonding. The current limiting resistor 25 may be a double-sided chip resistor. When the current limiting resistor 25 is pasted on the extension portion 201, the current limiting resistor 25 will be electrically connected to the power output GND. Therefore, the full-color LED unit 20 may operate in constant current mode to protect the chips.

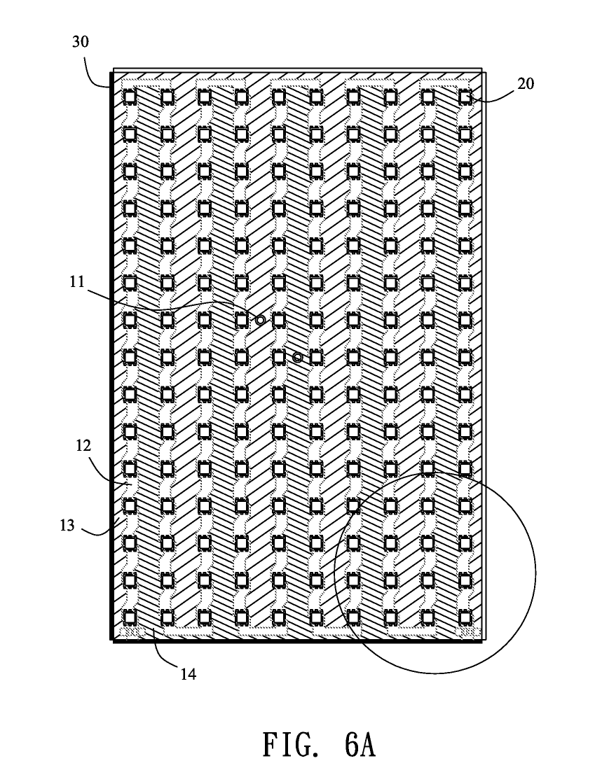

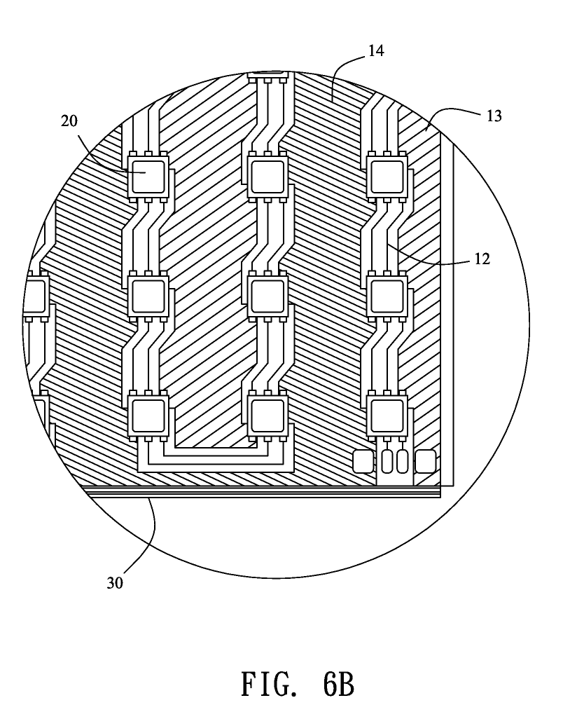

Please see FIGS. 6A and 6B, which are schematic views of the LED module plates 1 according to the present invention and illustrates using the positive area 13 and the negative area 14 for the power supply through holes 11.

The full-color LED units 20 are arranged on the flexible PCB 10 in a matrix, and the transmission line 12 is arranged to-and-fro to connect all the full-color LED units 20. The transmission line 12 would divide the flexible PCB 10 into two areas, which defined a positive area 13 and a negative area 14. Therefore, each full-color LED unit 20 is attached across the positive area 13 and the negative area 14. The pair of the power supply through holes 11 are attached in the positive area 13 and the negative area 14 respectively. When the supply voltage is supplied to the power supply through holes 11, all the full-color LED units 20 can receive the supply voltage to illuminate. Due to the supply voltage is supplied from the middle portion of the flexible PCB 10, not the endpoint of the transmission line 12, i.e. the input port 51 and the output port 52, the chromatic aberration caused by the delay of power signal transmission will be improved.

FIGS. 7A and 7B are schematic views of the LED display structure according to the present invention, illustrating using a conductive connecting element to connect the power supply through holes of the LED module plates.

The LED display structure is constructed of three LED module plates 1a, 1b, 1c by connecting edge banding 30. And the input port 51 and the output port 52 is connected by a connecting line 53. Therefore, the controlling signal is inputted from the input port 51 of the LED module plate 1a, and output from output port 52 of the

LED module plate la through the transmission line 12. Then the controlling signal is transmitted to the input port 51 of the LED module plate lb through connecting line 53 and go on. Hence, it's not need to provide the controlling signal for each LED module plate 1a, 1b, 1c. Furthermore, a pair of conductive connecting elements 54, such as made of copper, are disposed to connect the power supply through holes 11 of the LED module plates 1a, 1b, 1c, which located on the same areas of the flexible PCB 10.

Through the connecting edge banding 30 disclosed the present invention, the labor hour to assemble the LED module plates 1 to develop a larger LED display is decreased. When one of the LED units 20 is failure or breakdown, it is easy to repair by replacing a new modular LED module plates 1. The hanger 40 is also connected by the connecting edge banding 30. The LED display is suspended without complicated process. Moreover, the full-color LED units 20 are disposed on the flexible PCB 10, the LED module plate 1 or the assembled LED display is flexible and is enabled to roll. The package and transportation is more efficient. Also, due to each full-color LED unit 20 has driving mechanism, the density of the arrangement for the full-color LED units 20 pasted on the LED module plate 1 is increased. The supply voltage is supplied from the middle portion of the flexible PCB 10, not the endpoint of the transmission line 12, i.e. the input port 51 and the output port 52, the chromatic aberration caused by the delay of power signal transmission will be improved.

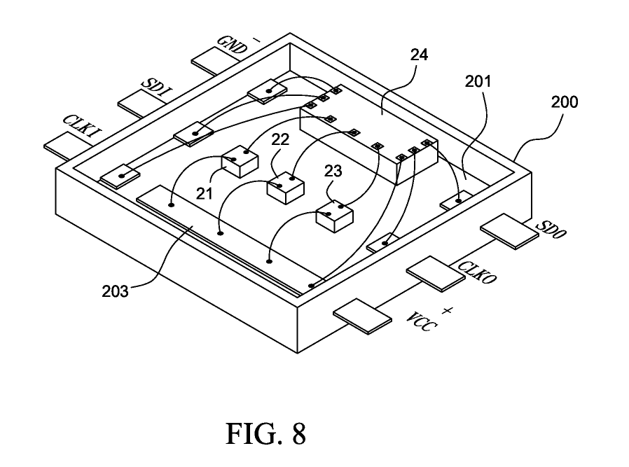

Please refer to FIG. 8, which is a schematic view of the package structure according to the present invention.

The package structure of the full-color LED equipped with driving mechanism has six pins, including a power input VCC, a power output GND, a clock input CLKI, a clock output CLKO, a serial data input SDI and a serial data output SDO. The package structure allocated inside a frame 200 includes a driving IC (Integrated Circuit) chip 24, a red LED dice 21, a green LED dice 22 and a blue LED dice 23. Each of the three red, green and blue LED dices 21-23 has a first electrode and a second electrode respectively configured thereon; all the three red, green and blue LED dices 21-23 are fixed on a carrier 101.

The power input VCC extends into the frame 200 to form a rectangular inputting extension section 203. On the inputting extension section 203, metal wirings are used for wire bonding to the first electrodes of the blue, red and green LED dices 23, 21, and 22. The second electrodes of the red, green and blue LED dice 21-23 connect to control points of the driving IC chip 24 through wire bonding. The driving IC chip 24 is pasted on the carrier 101, and is connected by wire bonding with the six pins including the power input VCC, the power output GND, the clock input CLKI, the clock output CLKO, the serial data input SDI and the serial data output SDO. Eventually, feed in light-mixing glue of light-pervious material to complete the package.

The red, green and blue LED dices 21-23 are controlled through a PWM (Pulse Width Modulation). The driving IC chip 24 controls the red, green and blue LED dices 21-23 after receiving an operation power from the power input VCC and receiving a control signal from the clock input CLKI and the serial data input SDI. The driving IC chip 24 further sends out the operation power through the power output GND and also sends out the control signal through the clock output CLKO and the serial data output SDO. The driving IC chip 24 further includes three current limiting elements to distribute the operation power into the red LED dice 21, the green LED dice 22 and the blue LED dice 23 respectively to ensure light colors generated by mixing lights of the LED dices 21-23 and to form protections for the LED dices 21-23. Because the current limiting elements are integrated into the driving IC chip 24, the current limiting resistors could be eliminated to reduce production costs and improve production yield rate.

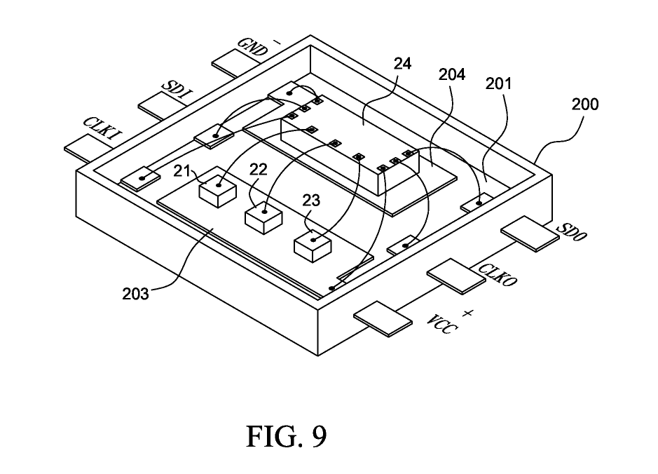

Please refer to FIG. 9, which is a schematic view of another embodiment of the package structure according to the present invention.

The red, green and blue LED dices 21-23 are vertical type chip with two electroconductive surfaces. The first electrode is on the bottom surface, and the second electrode is on the top surface. The red, green and blue LED dices 21-23 are pasted on the inputting extension section 203 to form electrical connection. Moreover, the power output GND extends into the frame 200 to form a rectangular outputting extension section 204. The driving IC chip 24 is pasted thereon. The outputting extension section 204 is made of metal to increase the efficiency for dispensing heat of the driving IC chip 24 during operation.

Through connecting the full-color LED disclosed the present invention, a large LED display screen may be integrated and formed; wherein each of the full-color LED 10 connects with another through cascade control. The control signals may be output through a large control end. In the control signals, there are clock (CLK) data for all the full-color LEDs to operate in synchronization, serial data (SD) for controlling the red, green and blue LED dices. After the full-color LED receives control signals from the clock input CLKI and the serial data input SDI, PWM (Pulse Width Modulation) may be used to control the light-color mixing of the red, green and blue LED dices. The control signals may be sent to another full-color LED through the clock input CLKO and the serial data input SDO. By means of said method, a designer many connect a large amount of full-color LEDs to form a large-scale LED display screen. Since the full-color LED has an IC chip and current limiting resistors, the intervals between the adjacent full-color LEDs so that the distance in-between is effectively shortened and a large-scale display screen may display finer images.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A package structure of full-color LED (Light Emitting Diode), comprising:
a power input, a power output, a clock input, a clock output, a serial data input and a serial data output;
a carrier having an inner space to dispose a red LED dice, a green LED dice and a blue LED dice, each of the red, green and blue LED dices being respectively configured with a first electrode and a second electrode thereon, the first electrodes of the red LED dice, the green LED dice and the blue LED dice connecting to the power input through metal wiring; and
a driving IC (Integrated Circuit) chip, being pasted on the carrier and respectively connecting with the second electrode of each of the red, green and blue LED dices through metal wiring, the driving IC chip controlling the red, green and blue LED dices after receiving an operation power from the power input and receiving a control signal from the clock input and the serial data input, the driving IC chip further sending out the operation power through the power output and also sending out the control signal through the clock output and the serial data output; wherein the driving IC chip further comprises three current limiting elements to distribute the operation power into the red LED dice, the green LED dice and the blue LED dice respectively to ensure light colors generated by mixing lights of the LED dices and to form protections for the LED dices.

2. The package structure of claim 1, wherein the red, green and blue LED dices are controlled through a PWM (Pulse Width Modulation).

3. The package structure of claim 1, wherein the power input extending to form an inputting extension section.

4. The package structure of claim 3, wherein the first electrodes of the red LED dice, the green LED dice and the blue LED dice are connected to the inputting extension section of the power input.

5. A package structure of full-color LED (Light Emitting Diode), comprising:
a power input, a power output, a clock input, a clock output, a serial data input and a serial data output, wherein the power input has an inputting extension section;
a carrier having an inner space to dispose a red LED dice, a green LED dice and a blue LED dice, each of the red, green and blue LED dices being pasted on the inputting extension section of the power input to form electrical connection; and
a driving IC (Integrated Circuit) chip, being pasted on the carrier and respectively connecting with the red, green and blue LED dices through metal wiring, the driving IC chip controlling the red, green and blue LED dices after receiving an operation power from the power input and receiving a control signal from the clock input and the serial data input, the driving IC chip further sending out the operation power through the power output and also sending out the control signal through the clock output and the serial data output; wherein the driving IC chip further comprises three current limiting elements to distribute the operation power into the red LED dice, the green LED dice and the blue LED dice respectively to ensure light colors generated by mixing lights of the LED dices and to form protections for the LED dices.

6. The package structure of claim 5, wherein the red, green and blue LED dices are controlled through a PWM (Pulse Width Modulation).

7. The package structure of claim 5, wherein the red, green and blue LED dices are vertical type chip with two electro-conductive surfaces.

8. The package structure of claim 7, wherein the red, green and blue LED dices are electrically connected to the inputting extension section of the power input by being directly pasted thereon.

9. The package structure of claim 5, wherein the power output extending to form an outputting extension section.

10. The package structure of claim 9, wherein the driving IC chip is pasted on the outputting extension section.

11. The package structure of claim 9, wherein the outputting extension section is made of metal to increase the efficiency for dispensing heat of the driving IC chip during operation.
